(19) United States
(12) Patent Application Publication
(10) Pub. No.: US 2021/0357924 A1
(43) Pub. Date: Nov. 18, 2021

(54) DISTRIBUTED-LEDGER BASED DISTRIBUTED TRANSACTION PROCESSING AS A BROKERED SERVICE

(71) Applicant: JPMORGAN CHASE BANK, N.A., New York, NY (US)

(72) Inventors: James A. TWING, Houston, TX (US); Eric Han Kai CHANG, Wilmington, DE (US); Tony M. NAZAROWSKI, Elgin, IL (US); Mizan MIAH, Wilmington, DE (US)

(21) Appl. No.: 17/319,555

(22) Filed: May 13, 2021

Related U.S. Application Data
(60) Provisional application No. 63/024,812, filed on May 14, 2020.

(51) Int. Cl. G06Q 20/38; G06Q 20/36; G06Q 30/02; H04L 9/06

(52) U.S. Cl. CPC G06Q 20/389; G06Q 20/363; H04L 2209/56; H04L 9/0618; H04L 2209/38; G06Q 30/0215

(57) ABSTRACT

Systems and methods for distributed ledger based distributed transaction processing as a brokered service are disclosed. In one embodiment, a method for generating a plurality of user transaction profiles may include: (1) receiving, at a computer program for a trusted entity, a transaction involving an account for a user; (2) retrieving, by the computer program, transaction profile information for the user, the transaction profile specifying a plurality of transaction profiles for the user, each transaction profile having a different anonymity level; and (3) writing, by the computer program and on a distributed ledger, the transaction to each transaction profile at the anonymity level for the transaction profile. The transaction profiles on the distributed ledger are linked to each other.

### RELATED APPLICATIONS

This application claims priority to, and the benefit of, U.S. Provisional Patent Application Ser. No. 63/024,812, filed May 14, 2020, the disclosure of which is hereby incorporated, by reference, in its entirety.

### BACKGROUND OF THE INVENTION

### 1. Field of the Invention

The present disclosure generally relates to distributed-ledger based distributed transaction processing as a brokered service. This may be provided, for example, as a replacement of, or supplement to, advertising revenue for content consumption.

### 2. Description of the Related Art

With the rise of ad-blocking services, many online content-providing sites are turning to blockchain-based tools, the value derived from which is used as a supplement, and in some cases a replacement to, the revenue raised through intrusive web page ads. While the value recovered can be as good or better than that provided via ads, for the content providers, the overall ecosystem is not healthy: these mining routines, often operated by untrusted providers, and without complete end-user transparency, open end-users up to additional costs and potential exposure to malicious automation.

Additionally, third parties are seeking to learn more about consumers so that they can better provide targeted ads. With the constant threat of identity theft, however, consumers and the entities that the consumers use (e.g., financial institutions) are reluctant to share information with these third parties.

### SUMMARY OF THE INVENTION

Systems and methods for distributed ledger based distributed transaction processing as a brokered service are disclosed. In one embodiment, a method for generating a plurality of user transaction profiles may include: (1) receiving, at a computer program for a trusted entity, a transaction involving an account for a user; (2) retrieving, by the computer program, transaction profile information for the user, the transaction profile specifying a plurality of transaction profiles for the user, each transaction profile having a different anonymity level; and (3) writing, by the computer program and on a distributed ledger, the transaction to each transaction profile at the anonymity level for the transaction profile. The transaction profiles on the distributed ledger are linked to each other.

In one embodiment, the transaction may include transaction details comprising a merchant name, a merchant type, and an amount.

In one embodiment, a first transaction profile may include non-anonymized transaction details, a second transaction profile may include semi-anonymized transaction details, and a third transaction profile may include fully anonymized transaction details. The first transaction profile may include the merchant name, the merchant type, and the amount; the second transaction may include anonymized merchant information and the amount; and the third transaction may include anonymized merchant information for the merchant and anonymized amount information for the amount.

In one embodiment, the transaction profiles may be cryptographically linked to each other.

According to another embodiment, a method for sharing transaction profiles may include: (1) receiving, at a computer program for a trusted entity, permission from a user to share one of a plurality of transaction profiles with a third party, each transaction profile having a different anonymity level; (2) retrieving, by the computer program, the transaction profile from a distributed ledger; and (3) providing, by the computer program, the transaction profile to the third party. The third party may be configured to provide a reward to a digital wallet for the user in response to receiving the transaction profile.

In one embodiment, a first transaction profile may include non-anonymized transaction details, a second transaction profile may include semi-anonymized transaction details, and a third transaction profile may include fully anonymized transaction details. The first transaction profile may include a merchant name, a merchant type, and an amount; the second transaction may include anonymized merchant information and the amount; and the third transaction may include anonymized merchant information for the merchant and anonymized amount information for the amount.

In one embodiment, the reward may include digital currency.

According to another embodiment, a method for sharing transaction profiles may include: (1) receiving, at a computer program for a trusted entity and from a third party, a request for one of a plurality of transaction profiles for a user, each transaction profile having a different anonymity level; (2) determining, by the computer program, a third-party type for the third party; (3) determining, by the computer program, an anonymity level for the transaction profile based on the third-party type; (4) retrieving, by the computer program, the transaction profile for the anonymity from a distributed ledger; and (5) providing, by the computer program, the transaction profile to the third party. The third party may be configured to provide a reward to a digital wallet for the user in response to receiving the transaction profile.

In one embodiment, a first transaction profile may include non-anonymized transaction details, a second transaction profile may include semi-anonymized transaction details, and a third transaction profile may include fully anonymized transaction details. The first transaction profile may include a merchant name, a merchant type, and an amount; the second transaction may include anonymized merchant information and the amount; and the third transaction may include anonymized merchant information for the merchant and anonymized amount information for the amount.

In one embodiment, the reward may include digital currency.

In one embodiment, the transaction profiles may be cryptographically linked to each other.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for distributed ledger-based distributed transaction processing as a brokered service according to one embodiment;

FIGS. 2A, 2B, and 2C depict exemplary transaction profiles according to one embodiment;

FIG. 3 depicts a method of generating a plurality of transaction profiles for a user according to one embodiment; and

FIG. 4 depicts a method of sharing transaction profiles according to one embodiment.

### DETAILED DESCRIPTION OF PREFERRED EMBODIMENTS

Embodiments are related to distributed ledger based distributed transaction processing as a brokered service.

Embodiments may leverage an organization's trust to provide a marketplace where third parties, such as merchants, aggregators, content providers, etc. may provide interact with the users (e.g., customers of the organization) via a marketplace. In return for participating in the marketplace, the third parties may receive anonymized profile data for one or more user, an aggregation of profiles for a plurality of users, etc. In one embodiment, the anonymized profile data may assist the third parties in targeting their content to users having a certain profile.

The trusted organization may be, for example, a financial institution, a financial technology (FinTech) provider, etc.

In one embodiment, the user may select the transaction profile that is made available to the third parties, may decide which third parties to share the transaction profile with, etc. In another embodiment, the third party may be categorized, and the transaction profile may be automatically selected according to the category.

In one embodiment, the user may protect their identity, specific transaction information, etc. from any third party, other than the trusted entity, such as a financial institution, that sponsors or provides the distributed ledger creation and maintenance, as well as a subsequent marketplace for rewards, digital currency, etc. For example, the user may opt to completely hide its personal identity from any other third party, with the only thing that certifies them as a real person is the evidence (e.g., the transactions) on the distributed ledger at the appropriate level of anonymity and the trust placed by all third parties in the distributed ledger and the trusted institution.

In one embodiment, to receive a reward for sharing personal information at one of the anonymized levels, the user only need to meet objective non-personalized criteria set by the offering parties, be they content providers, advertisers, etc.

In one embodiment, a marketplace may provide a portal through which the user may select the transaction profile, amount of data that is shared (e.g., the anonymity level), the third parties with which data is shared, etc. In one embodiment, the user may make specific selections, may make general selections, etc.

In one embodiment, the portal may be provided as part of an application or service by the organization. In one embodiment, an OAUTH-like authorization system may be used to facilitate the relationship with the third party which may facilitate the sharing of data.

In one embodiment, a distributed ledger may be provided to provide assurances that the transaction profile data is genuine. For example, the distributed ledger may maintain transactions at the desired level of anonymity in a plurality of transaction profiles or may generate the transaction profiles at the desired levels of anonymity based on the transactions. In one embodiment, the transactions may be maintained in a non-anonymized state and may be anonymized at the desired level when the transaction profiles are created or maintained.

In one embodiment, the user may receive discounts, rewards, non-traditional currencies (e.g., cryptocurrency) in exchange for releasing their anonymized profile data.

In one embodiment, a distributed ledger may manage the participants, accounts for rewards, discounts, alternative currencies, etc.

In embodiments, the user may choose to associate one of the user's transaction profiles with an application or a web client and may only use the non-anonymized transaction profile with interacting with the financial institution that manages their digital wallet and profile portfolio and/or any other entity that the user may wish to share this information with. For example, for an email account or email application, the user may select a fully anonymized transaction profile to be shared with advertisers. When the user accesses certain content, the user may select a less anonymized transaction profile to share with the content provider for that portion of the online session.

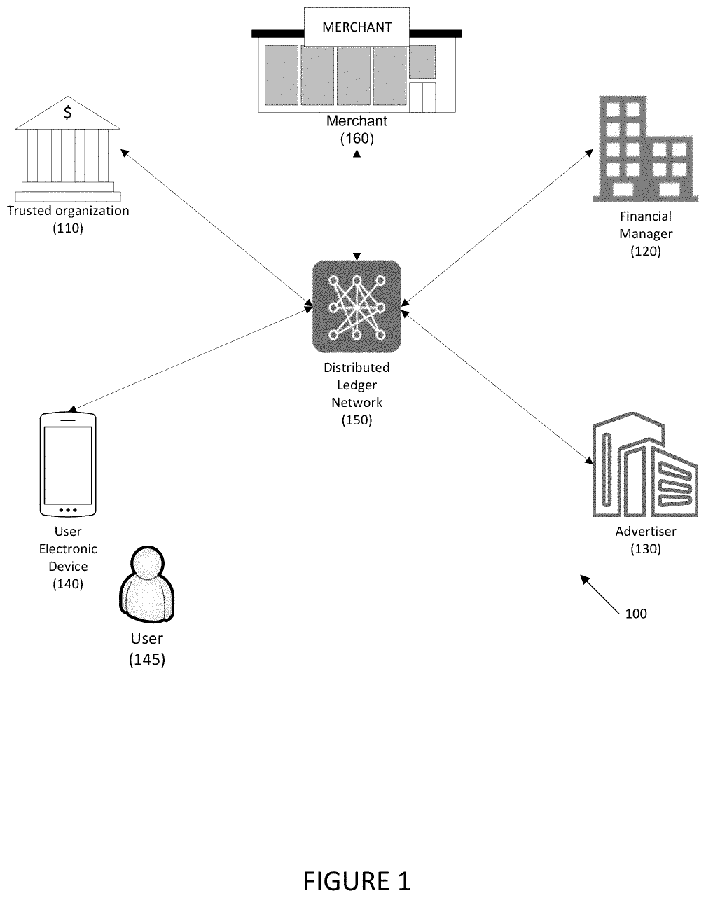

Referring to FIG. 1, a system for distributed ledger-based distributed transaction processing as a brokered service is disclosed according to one embodiment. System 100 may include trusted organization 110, such as a bank or financial institution, financial manager 120, and advertiser 130. In one embodiment, each of trusted organization 110, financial manager 120, and advertiser 130 may receive different levels of transaction details. For example, trusted organization 110 may be provided with a high level of transaction details (e.g., merchant, amount, date, etc.), whereas financial manager 120 may be provided with an intermediate level of transaction details (e.g., amount, merchant category, etc.) and advertiser 130 may be provided with a low level of transaction details (e.g., general amount, merchant category, etc.). It should be noted that additional levels of transaction details may be used as is necessary and/or desired, and user 145 may set the level of transaction details that may be shared with each third party as is necessary and/or desired.

In one embodiment, user 145 may have a plurality of transaction profiles, such as a non-anonymized transaction profile used with trusted organization 110, a semi-anonymized transaction profile used with financial manager 120, and a fully anonymized transaction profile used with advertiser 130. For example, when user 145 makes a purchase, the non-anonymized transaction profile may provide exact details on the transaction, such as the amount, merchant name, a description of the purchase, etc., while a semi-anonymized transaction profile may provide the amount, a merchant type, a general description of the goods/services, etc. And, a fully anonymized transaction profile may simply identify the merchant type and a general dollar amount.

The transaction profile type may depend on the type of third party to which the transaction profile is provided. For example, a transaction profile with a third party that provides budgeting services may be different than a transaction profile for a third-party vendor, which may be different from a transaction profile that the user may present to an third party that provides advertisements or presents offers to user 145.

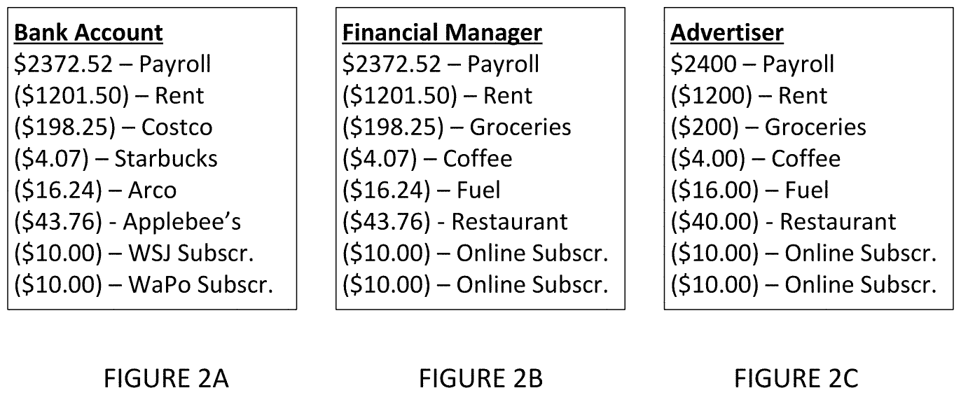

Examples of different transaction profiles are provided in FIGS. 2A, 2B, and 2C. For example, a user may have a transaction profile for trusted organization 110 (FIG. 2A) that may provide complete spending details (e.g., amount, merchant, etc.). The user may have transaction profile with financial manager 120 (FIG. 2B) that may provide partial transaction details (e.g., amount, general description of goods/services). And, the user may have a transaction profile that may be shared with advertiser 130 (FIG. 2C) that may provide general amounts and a general description of the goods/services. The amount by which the amounts are rounded may be set by the customer, by the sponsoring institution, etc. as is necessary and/or desired.

In one embodiment, trusted organization 110, financial manager 120, and advertiser 130 may participate as nodes in distributed ledger network 150. Further, although only one trusted organization 110, financial manager 120, and advertiser 130 are illustrated in FIG. 1, it should be noted that third parties, such as financial institutions, financial managers 120, and/or advertisers 130 may be included as is necessary and/or desired.

In one embodiment, system 100 may include merchant 160, which may write transactions conducted by user 145 to distributed ledger network 150. In one embodiment, merchant 160 may participate as a node in distributed ledger network 150 or may participate indirectly using an API or similar to post transactions to distributed ledger network 150. Multiple merchants 160 may be included as is necessary and/or desired.

In one embodiment, trusted organization 110 may post transactions conducted by user 145 to distributed ledger network on behalf of merchant(s) 160.

Trusted organization 110 may be an institution with which user 145 may hold one or more accounts, such as a demand deposit account (DDA), savings account, credit card account, etc. In one embodiment, trusted organization 110 may receive the highest level of transaction details involving transactions involving user 145. In one embodiment, the transaction details may be limited to transaction details for accounts that user 145 may have with trusted organization 110.

Financial manager 120 may be any suitable third party that may analyze financial information for user 145. In one embodiment, financial manager 120 may not require full information for merchant(s) 160 with which user 145 may conduct transactions, but may instead receive details necessary for budgeting, preparing financial advice, etc. For example, financial manager 120 may receive transaction amounts and merchant categories.

Advertiser 130 may be any third party that may provide advertisements, offers, etc. to user 145. In one embodiment, advertiser 130 may provide advertisements, offers, etc. to user electronic device 140 in the form of banners, pop-up ads, emails, in-app messages, etc. Advertiser 130 may be a provider of information, such as an online news service, that may present advertisements to user 145. In another embodiment, advertiser 130 may be a merchant.

In one embodiment, advertiser 130 may serve advertisements to content provider, such as online news providers, merchants, etc., for presentation to user 145.

As noted above, user 145 may select the transaction profile that is shared with trusted organization 110, financial manager 120, and/or advertiser 130. In one embodiment, user 145 may further identity the entities with which each transaction profile may be shared.

In one embodiment, advertiser 130 may compensate or reward user 145 for sharing one of user 145's transaction profiles. For example, advertiser 130 may issue digital currency to user 145's digital wallet that may be maintained on distributed ledger network 150, by trusted organization 110, etc. as is necessary and/or desired.

In one embodiment, each transaction profile may be linked or associate with the most detailed transaction profile. For example, each transaction profile that provides less than full transaction data may be sub-chains of the full transaction data. As a transaction is received by distributed ledger network 150, distributed ledger network 150, such as a smart contract, may write the transaction to different transaction profiles at different detail levels as specified by user 145. Because each transaction profile is associated with the detailed transaction profile, financial manager 120 and advertiser 130 may have confidence that that transaction profiles that they receive are for a real individual.

In one embodiment, user 145 may redeem digital currency in user 145's digital wallet with trusted organization 110, or user 145 may use the digital currency to conduct transactions with one or more merchant 160.

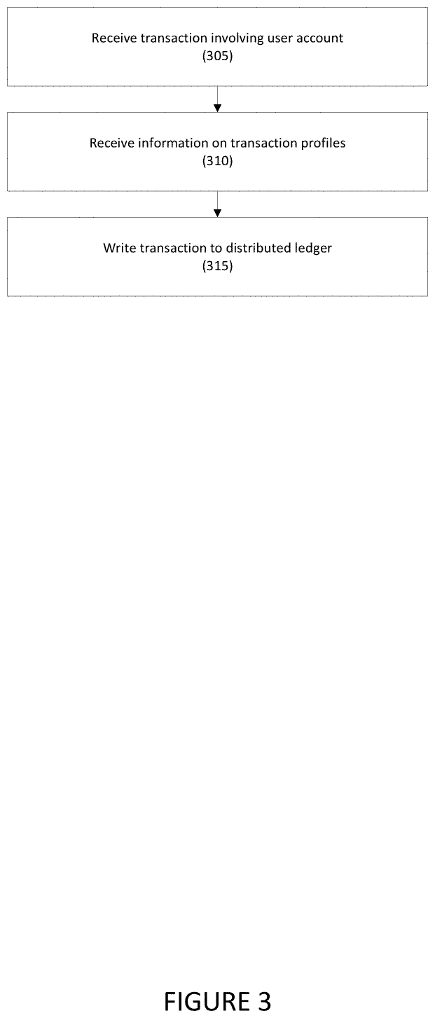

Referring to FIG. 3, a method of generating a plurality of transaction profiles for a user is provided according to an embodiment. In step 305, a transaction involving a user may be received at a distributed ledger network. For example, a merchant, financial institution, etc. may post a transaction to the distributed ledger network with full transaction details, such as merchant name, merchant type, date, amount, account involved, etc.

In one embodiment, the transaction may be received at a node for the distributed ledger.

In step 310, the distributed ledger network may receive transaction profile information for the user. In one embodiment, the user may specify the number, the level of transaction detail to include, and the entities/types of entities with which each transaction profile may be shared. For example, the user may specify three transaction profiles, such as a non-anonymized transaction profile, a semi-anonymized transaction profile, and a fully anonymized transaction profile. The user may further specify any transaction or transaction types to exclude, etc.

In step 315, the distributed ledger network may write the transaction to the plurality of transaction profiles at the specified level of anonymity. In one embodiment, a smart contact may write the transaction to the plurality of transaction profiles at the specified level of anonymity for each transaction profile. In another embodiment, a computer program executed by the trusted organization, such as a financial institution, may write the transaction to the distributed ledger at the specified levels of anonymity.

In one embodiment, the plurality of transaction profiles may be linked or associated with each other, or with the non-anonymized transaction profile. For example, the transaction profiles may be written to different chains on the distributed ledger and may be cryptographically linked. As another example, the different chains may include a common identifier that may be used to link them together. In another embodiment, the transaction profiles may be written to the same chain on the distributed ledger. Any other suitable manner for linking the transaction profiles may be used as is necessary and/or desired.

In one embodiment, each transaction profile may include cryptographic metadata that allows each transaction profile to be independently verified as a parent or child of another transaction profile, and whether it precedes or follow a block on the distributed ledger.

In another embodiment, the transaction may be written to the distributed ledger as a non-anonymized transaction, and the partially anonymized and/or fully anonymized transaction profiles may be generated based on the non-anonymized transaction profile as necessary and/or desired to provide to a third party. For example, a smart contract or program executed by the trusted organization, such as a financial institution, may retrieve transactions from the distributed ledger and may generate the transaction profile(s) as required for the third party that the transaction profile is being shared with.

In one embodiment, because that the transaction profile is provided by trusted organization 110, and the transactions in the transaction profiles, regardless of anonymity level, are cryptographically verifiable, third parties such as other financial institutions, financial manager(s) 120, advertiser(s) 130, etc. may have confidence that the transaction profiles provided them by trusted organization 110 represent a transactions for an actual person.

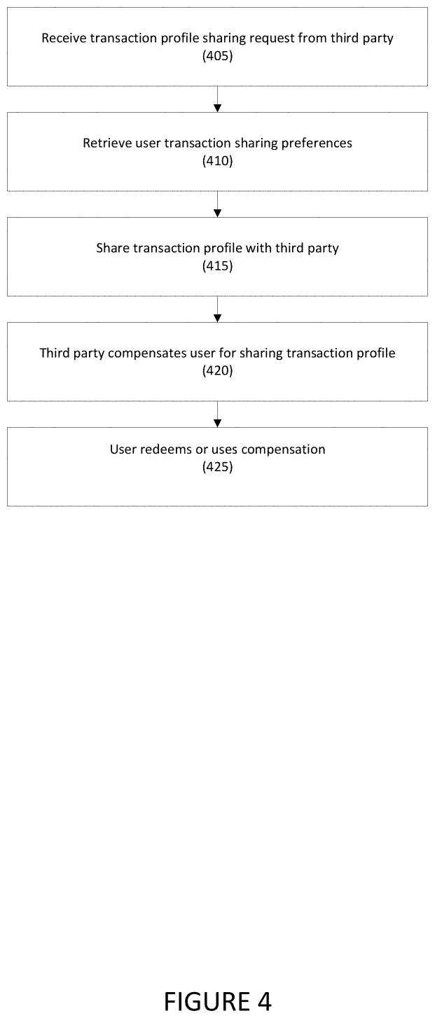

Referring to FIG. 4, a method of sharing transaction profiles is disclosed according to one embodiment.

In step 405, a user may authorize sharing one of the plurality of transaction profiles with a third party. In one embodiment, the user may authorize the sharing during transaction profile set-up; in another embodiment, the third party may request the transaction profile from the user, the trusted organization, etc.

In step 410, a smart contract executed by the distributed ledger may retrieve the user's preferences for sharing transaction profiles. For example, the smart contract may determine the type of third party and the type of transaction profile to be shared. In another embodiment, a computer program executed by the trusted organization, such as a financial institution, may determine the type of third party and type of transaction profile to be shared.

In one embodiment, if the type of third party cannot be determined, the smart contract may share the fully anonymized profile.

In another embodiment, the user may specifically identify and authorize sharing a specific transaction profile with the third party.

In step 415, the smart contract may share the identified transaction profile with the third party. In one embodiment, the identified transaction profile may be shared on the distributed ledger. In another embodiment, the identified transaction profile may be shared over a separate communication channel (e.g., email, FTP, etc.).

In one embodiment, the identified transaction profile may be digitally signed by, for example, the trusted organization, a smart contact, etc.

In one embodiment, the third party may optionally verify that the received transaction profile is associated with an actual user.

In step 420, the third party may optionally compensate the user for sharing the transaction profile. In one embodiment, the third party may issue digital currency to a digital wallet associated with the transaction profile to the distributed ledger. In another embodiment, the third party may issue compensation to the trusted organization, which may then credit the user's digital wallet with the compensation. The compensation may include, for example, digital currency, discounts, rewards, etc.

In step 425, the user may redeem or otherwise use the digital currency in the user's digital wallet. For example, the user may redeem the digital currency for fiat currency into a user's account with a financial institution or may use the digital currency to purchase something from one or more merchant, access content from a content provider, etc.

In one embodiment, the user may receive rewards the user's digital wallet for future purchases, account credits, etc. In one embodiment, a third party may offer discounts, free goods/services, etc. in exchange for the transaction profile information. For example, the user may receive a discount, free articles, etc., from a content provider.

In another embodiment, the trusted organization's position may be leveraged to distribute trusted, standardized, cryptographically-verified, and easily-adopted distributed ledger (e.g., blockchain) code modules. These modules protect the end user by providing the end user with specific service-level guarantees, such as reducing or eliminating activity while on battery power or while connected to expensive and/or roaming data networks, while delivering the aggregated value of the processing activities back to the content providers that the user frequently interacts with. Embodiments may include a mechanism by which a user's participation in the program may be communicated to the content provider allows the provider to properly compensate the user.

Users may allow the miners running to accrue additional credits, which may be redeemable for the organization's share of the exchange, for other products and services. This may include, for example, digital currency, rewards points, air travel miles, branded merchandise, cash-back, etc.

Embodiments may facilitate system growth, scaling out on a per-user and per provider basis to cover the growing market share of that provider, because the transaction processing itself (as is the nature of blockchain) can be decentralized and shared across the network of participating client devices, in concert with centralized systems for orchestration.

Embodiments may users to purchase viewing credits for in-app purchases using, for example, digital currency.

Embodiments may also include a mechanism by which a user's participation in the program may be communicated to the content provider allows the provider to verify the authenticity of the data.

In embodiments, mechanisms to perform one or more of the following may be provided: establish and/or cross-check the identifies of individual user devices, distribute and synchronize transaction history across devices that may be tied to a committed bank transaction, anonymize transaction details to enable anonymous participation in loyalty programs, anonymize transaction details to enable anonymous participation in third party budget software (e.g., refer to anonymized distributed ledger history), anonymously provision micropayments to enable online transactions via a separate “wallet” that may be independent of the financial institution login credentials, or personally-identifiable details, enable rewards (e.g., loyalty, card points, air miles) to be exchanged or awarded as funds applied to wallets, etc.

Hereinafter, general aspects of implementation of the embodiments will be described.

Embodiments of the invention or portions of thereof may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for generating a plurality of user transaction profiles, comprising:
receiving, at a computer program for a trusted entity, a transaction involving an account for a user;
retrieving, by the computer program, transaction profile information for the user, the transaction profile specifying a plurality of transaction profiles for the user, each transaction profile having a different anonymity level; and
writing, by the computer program and on a distributed ledger, the transaction to each transaction profile at the anonymity level for the transaction profile;
wherein the transaction profiles on the distributed ledger are linked to each other.

2. The method of claim 1, wherein the transaction comprises transaction details comprising a merchant name, a merchant type, and an amount.

3. The method of claim 2, wherein a first transaction profile comprises non-anonymized transaction details, a second transaction profile comprises semi-anonymized transaction details, and a third transaction profile comprises fully anonymized transaction details.

4. The method of claim 3, wherein the first transaction profile comprises the merchant name, the merchant type, and the amount.

5. The method of claim 3, wherein the second transaction comprises anonymized merchant information and the amount.

6. The method of claim 3, wherein the third transaction comprises anonymized merchant information for the merchant and anonymized amount information for the amount.

7. The method of claim 1, wherein the transaction profiles are cryptographically linked to each other.

8. A method for sharing transaction profiles, comprising:
receiving, at a computer program for a trusted entity, permission from a user to share one of a plurality of transaction profiles with a third party, each transaction profile having a different anonymity level;
retrieving, by the computer program, the transaction profile from a distributed ledger; and
providing, by the computer program, the transaction profile to the third party;
wherein the third party is configured to provide a reward to a digital wallet for the user in response to receiving the transaction profile.

9. The method of claim 8, wherein the plurality of transaction profiles comprise a first transaction profile that comprises non-anonymized transaction details, a second transaction profile that comprises semi-anonymized transaction details, and a third transaction profile that comprises fully anonymized transaction details.

10. The method of claim 9, wherein the first transaction profile comprises a merchant name, a merchant type, and an amount for a transaction.

11. The method of claim 9, wherein the second transaction comprises anonymized merchant information and an amount for the transaction.

12. The method of claim 9, wherein the third transaction comprises anonymized merchant information for a merchant and anonymized amount information for an amount for a transaction.

13. The method of claim 8, wherein the reward comprises digital currency.

14. A method for sharing transaction profiles, comprising:
receiving, at a computer program for a trusted entity and from a third party, a request for one of a plurality of transaction profiles for a user, each transaction profile having a different anonymity level;
determining, by the computer program, a third-party type for the third party;
determining, by the computer program, an anonymity level for the transaction profile based on the third-party type;
retrieving, by the computer program, the transaction profile for the anonymity from a distributed ledger; and
providing, by the computer program, the transaction profile to the third party;
wherein the third party is configured to provide a reward to a digital wallet for the user in response to receiving the transaction profile.

15. The method of claim 14, wherein the plurality of transaction profiles comprise a first transaction profile that comprises non-anonymized transaction details, a second transaction profile that comprises semi-anonymized transaction details, and a third transaction profile that comprises fully anonymized transaction details.

16. The method of claim 15, wherein the first transaction profile comprises a merchant name, a merchant type, and an amount for a transaction.

17. The method of claim 15, wherein the second transaction comprises anonymized merchant information and an amount for the transaction.

18. The method of claim 15, wherein the third transaction comprises anonymized merchant information for a merchant and anonymized amount information for an amount for a transaction.

19. The method of claim 14, wherein the reward comprises digital currency.

20. The method of claim 14, wherein the transaction profiles are cryptographically linked to each other.
